(19) United States
(12) Patent Application Publication
(10) Pub. No.: US 2018/0114207 A1
(43) Pub. Date: Apr. 26, 2018

(54) SYSTEM AND METHOD FOR SECURE ACCESS TO FINANCIAL SERVICES DEVICE FEATURES

(71) Applicant: JPMorgan Chase Bank, N.A., (US)

(72) Inventors: William BUDDE, Dublin, OH (US); Joseph Bradley NOLAN, New Albany, OH (US)

(73) Assignee: JPMorgan Chase Bank, N.A., New York, NY (US)

(21) Appl. No.: 13/749,952

(22) Filed: Jan. 25, 2013

(51) Int. Cl. G06Q 20/10

(52) U.S. Cl. CPC G06Q 20/1085

(57) ABSTRACT

A system and method is provided to enable secure verification of a customer's identity at a financial services device, such as, for example, an ATM or financial services kiosk, to override predetermined settings to enable the customer to complete a transaction that might not otherwise be able to be completed. For example, the customer may, using the method, override a daily withdrawal limit or a waiting period for funds availability. The method may be applied to other actions as well. The method provides a second level of authentication, beyond the login identity of the customer (which has already been entered into the financial services device by the customer in order to initiate the transaction).

### FIELD OF THE INVENTION

The invention relates generally to providing financial services, such as through devices such as financial services kiosks and Automated Teller Machines.

### BACKGROUND OF THE INVENTION

Financial institution customers use Automated Teller Machines (“ATMs”) to perform certain financial institution transactions. Each ATM is typically associated with at least one financial institution. Among the typical transactions performed at ATMs, customers make withdrawals of cash from the ATM. Financial institutions put a daily limit on such withdrawals. Once this daily limit is reached, no further funds can be withdrawn. The customer is unable to override this limit. Thus, if additional cash is required, the customer must seek other options. Similar limitations exist on availability of funds from deposits. The deposited funds can only be accessed after a predetermined period of time that depends on the deposit amount. Again, the customer is unable to override these time limits. Thus, if a customer needs access to the funds sooner, they must seek other options.

These and other deficiencies exist.

### SUMMARY OF THE INVENTION

An exemplary embodiment includes a method with the steps of receiving, electronically, a transaction request at a financial services device from a customer; transmitting, electronically, a code to a portable electronic device associated with the customer; receiving, electronically, an entry of the code at the financial services device; performing, electronically, a comparison of the entered code with the transmitted code; and completing the transaction upon a successful comparison.

Another exemplary embodiment includes a method with the steps of receiving, electronically, a transaction request at a financial services device from a customer; performing facial recognition by taking a digital image of the customer using the financial services device using a digital imaging device associated with the financial services device; performing, electronically, a comparison of the digital image with a stored digital image of the customer; and completing the transaction upon a successful comparison.

Another exemplary embodiment includes a method with the steps of receiving a transaction request for a transaction at a financial services device from a customer, wherein the transaction request is performed following a login to the financial services device; receiving, following the transaction request, a credential verifying the customer's identity at the financial services device, wherein the credentials are separate and distinct from the login; performing a validation of the credential to confirm the customer's identity; and completing the transaction upon a successful validation.

In other exemplary embodiments, the preceding methods may be performed using a system with a processor and a memory comprising computer-readable instructions which when executed by the processor cause the processor to perform the method steps.

These and other embodiments and advantages of the invention will become apparent from the following detailed description, taken in conjunction with the accompanying drawings, illustrating by way of example the principles of the various exemplary embodiments.

### BRIEF DESCRIPTION OF THE DRAWINGS

FIG. 1 is a diagram of a system in accordance with an exemplary embodiment.

FIG. 2 is a flow chart of a method of interfacing with a financial services device in accordance with an exemplary embodiment.

FIG. 3 is a flow chart of a method of interfacing with a financial services device in accordance with an exemplary embodiment.

FIG. 4 depicts a flow chart of a method of interfacing with a financial services institution according to an exemplary embodiment.

FIG. 5 depicts a flow chart of a method of interfacing with a financial services institution according to an exemplary embodiment.

### DETAILED DESCRIPTION OF THE PREFERRED EMBODIMENTS

It will be readily understood by those persons skilled in the art that the embodiments of the inventions described herein are capable of broad utility and application.

Accordingly, while the invention is described herein in detail in relation to the exemplary embodiments, it is to be understood that this disclosure is illustrative and exemplary of embodiments of the invention and is made to provide an enabling disclosure of the invention. Accordingly, the disclosure is not intended to be construed to limit the embodiments of the invention or otherwise to exclude any other such embodiments, adaptations, variations, modifications and equivalent arrangements. While the various embodiments of the present invention are described in the context of financial transaction/services devices and providing of financial service through such devices, the methods and systems described herein may be applied to other related services involving interaction with similar devices.

The following descriptions are provided of different configurations and features according to exemplary embodiments. These configurations and features may relate to providing financial services through financial services devices. While certain nomenclature and types of applications/hardware are described, other names and application/hardware usage is possible and the nomenclature provided is done so by way of non-limiting examples only. Further while particular embodiments are described, it should be appreciated that the features and functions of each embodiment may be combined in any combination as is within the capability of one of ordinary skill in the art. The attached Figures provide additional details regarding the present invention. It should also be appreciated that these exemplary embodiments are provided as non-limiting examples only.

Financial services devices, as used herein, may include machines, kiosks, and stations for performing financial services transactions. These devices include, but are not limited to, automated teller machines (“ATMs”), personal teller machines (“PTMs”), financial self-service devices, financial services kiosks, financial transaction devices, portable electronic devices, money machines, cash machines, bank machines, and bancomats.

According to exemplary embodiments, a system and method may be provided to enable secure verification of a customer's identity at a financial services device, such as an ATM. The secure verification may be used to override predetermined settings to enable the customer to complete a transaction that might not otherwise be able to be completed. These types of transactions may be referred to as secured transactions. For example, the customer may a daily withdrawal limit or a waiting period for funds availability using the secure verification process described herein. The method may be applied to other transactions as well, such as overriding a waiting period for funds availability following a deposit. To enable the secure verification, the method provides a second level of authentication, beyond the login identity of the customer (which has already been entered into the financial services device by the customer in order to initiate the transaction).

To be able to use the present method, the customer may first be required to register a mobile device with the financial institution. The mobile device may be a portable electronic device that is associated with or owned by the customer. For example, the portable electronic device may be a smart phone or a tablet computing device. The customer may register their device using a mobile application installed on the device. The mobile application may be associated with the financial institution and may be downloaded and installed by the customer. The customer may be required to have the mobile application installed on the device. The mobile application may be the focal point of communications between the financial institution and the mobile device in order to use the methods described herein. Alternatively, a website may be used to register the device. The website may be associated with the financial institution. In this embodiment, the customer may be prompted as part of the registration to install the mobile application.

By registering the device, the mobile device is associated with the customer's accounts that are administered by the financial institution and used by the customer. Subsequently, when the customer is at a financial services device associated with the financial institution, and desires to conduct a transaction that is from a particular set of transactions, that is, a secured transaction, a secure code may be sent to the mobile device by the financial institution. The customer may then enter this code into the financial services device as verification of their identity to complete the desired transaction. The secure code may be transmitted to and accessed from the installed application on the mobile device.

Other methods of authentication may be used in addition to or in place of the secure code described above. For example, a QR type code may be used. Additionally, this method of verification may be used for other services with the financial institution.

According to some embodiments, following the registration of the mobile device, a set of credentials may be loaded onto the mobile device. These credentials may be secure and may be securely loaded into the mobile application. Thus, when a secure code is required (as described above), the customer may be prompted to use the installed credentials. The credentials may consist of a code or an image which may be input or presented to the financial services device. In this manner, the customer may be prescreened or precredentialed to conduct the secured transaction. No additional code may be required to be sent to the customer to support validation of the customer's identity. These credentials may be used in place of or in addition to the secure code described above.

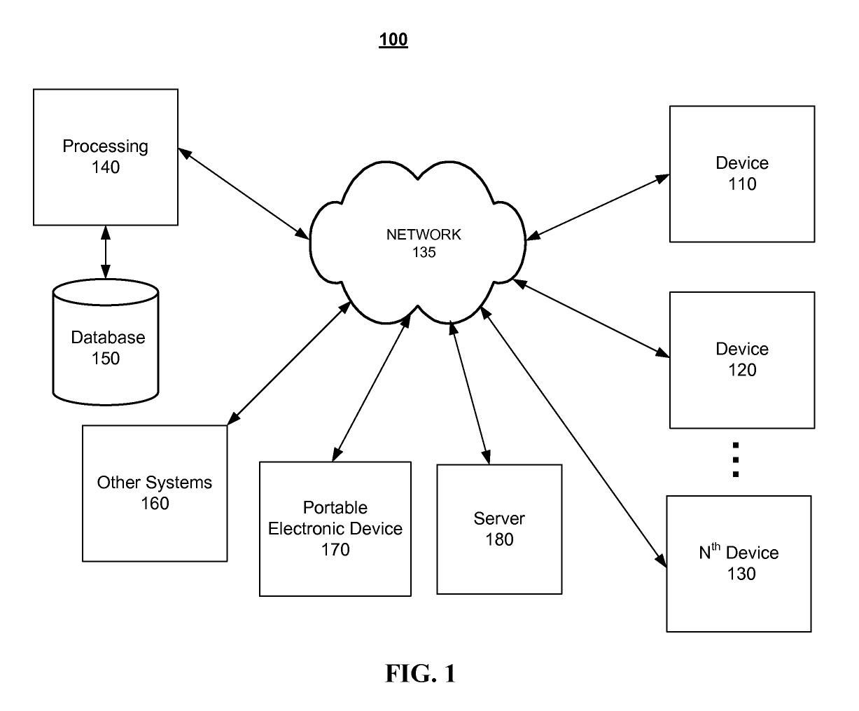

FIG. 1 is a system according to an exemplary embodiment of the invention. System 100 may provide various functionality and features associated with the program. More specifically, system 100 may include a device 110, a second device 120, and an Nth device 130, a network 135, a processing module 140, a database 150, and other systems 160. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized. It should be appreciated that system 100 may be integrated into and run on a computer, which may include a programmed processing machine which has one or more processors. Such a processing machine may execute instructions stored in a memory to process the data. System 100 may be integrated into and run on one or more computer networks which may each have one of more computers associated therewith.

As noted above, the processing machine executes the instructions that are stored in the memory or memories or persistent or non-transitory data storage devices to process data. This processing of data may be in response to commands by a user or users of the processing machine, in response to previous processing, in response to a request by another processing machine and/or any other input, for example. As described herein, a module performing functionality may have a processor.

According to exemplary embodiments, the system 100 may be configured to carry out the methods as described herein. The system 100 may have device 110 associated therewith. A second device 120 and an Nth device 130 may be further associated with the system 100. The devices 110, 120, and 130 may each be a processing machine. Each device 110, 120, and 130 may include software and/or modules to implement the methods described herein according to exemplary embodiments. Each device 110, 120, and 130 may provide processing, display, storage, communications, and execution of commands in response to inputs from a user thereof and respond to requests from the software and/or modules.

The devices 110, 120, and 130 may each serve as a client side. Each device 110, 120, and 130 may be a “fat” client, such that the majority of the processing may be performed on the client. Alternatively, the device 110, 120, and 130 may each be a “thin” client, such that the majority of the processing may be performed in the other components of the system 100 as best shown in FIG. 1. The devices 110, 120, and 130 may be configured to perform other functions and processing beyond the methods described herein. The devices 110, 120, and 130 may each be a part of a larger system associated with the financial institution. The devices 110, 120, and 130 may be multi-functional in operation.

Each device 110, 120, and 130 may have a display and an input device associated therewith. The display may be monochrome or color. For example, the display may be a plasma, liquid crystal, or cathode ray tube type display. The displays may be touch screen type displays. The devices 110, 120, and 130 may have more than one display. The multiple displays may be different types of displays. The display may have sub-displays there on. For example, the device 110, 120 and 130 may have a large display surface. The display for the user interface may occupy a portion or less than the whole of the large display surface.

The input device may be a single device or a combination of input devices. For example, the input devices may include a keyboard, both full-sized QWERTY and condensed, a numeric pad, an alpha-numeric pad, a track ball, a touch pad, a mouse, selection buttons, and/or a touch screen. As described above, the display may serve as an input device through using or incorporating a touch screen interface. The devices 110, 120, and 130 may include other devices such as a printer and a device for accepting deposits and/or dispensing currency and coins.

The device 110, 120, and 130 may have one or more cameras, optical sensors, or other sensing devices. The sensors may be computer controlled and may capture digital images.

According to some embodiments, the devices 110, 120, and 130 may be financial services devices as described herein. The financial services device may be a transaction device for conducting transactions with the financial institution. For example, the devices 110, 120, and 130 may be an ATM. In other embodiments, the devices 110, 120, and 130 may be financial services kiosks. In some embodiments, the devices 110, 120, and 130 may be a portable or hand-held computing or electronic device, or other type of computing device, that has the described functionality. For example, the devices 110, 120, and 130 may be a tablet computing device. The tablet computing device may be used to perform transactions similar or the same as those at a traditional ATM as described herein. Additional devices may be coupled to the portable or hand-held computing device to perform various functions such as accepting deposits or dispensing currency.

The devices 110, 120, and 130 may provide various functionality and features for conducting transactions with the financial institution. Accordingly, the devices 110, 120, and 130 may be referred to as financial transaction devices. For example, the devices 110, 120, and 130 may be capable of accepting deposits and mixed deposits, withdrawals and multi-denomination withdrawals, coin deposits/withdrawal, check cashing, statement printing, wires, bill pay and check printing. It should be appreciated that the devices 110, 120, and 130 may be capable of other functions and features. Transactions may be supported relating to other financial institutions. For example, the device may be part of a network associated with more than one financial institution. The network may be managed by a third party.

The devices 110, 120, and 130 may have a log-in device associated therewith. The log-in device may be used to allow access to the device. The log-in device may require a particular input or it may accept a combination of inputs. The input may serve as an authentication of the user to the device 110, 120, or 130 and the system 100 in general. Various authentication or log-on systems and methods may be used. For example, these methods and systems may include entering a password or PIN (Personal Identification Number) or using a card to log-on, either via swiping the card through a reader, such as a magnetic stripe reader or a smart chip reader, or through a radio frequency system (which may require that the card be placed in proximity to an appropriate reader (i.e., a contactless system), such as RFID (Radio Frequency Identification) or NFC (Near Field Communications). For example, the blink® system may be used. It should be appreciated that the card may include a combination of a magnetic stripe, a smart chip, and radio frequency. Further, the use of the card is exemplary only and the card may include fobs, stickers, and other devices. Biometrics may be used, such as fingerprints, facial recognition, speech recognition, or retinal scan. A combination of these systems may be used. Biometrics may be used in addition to other log-in methods and systems.

The devices 110, 120, and 130 may be communicatively coupled to a network 135. Accordingly, the devices 110, 120, and 130 may be geographically dispersed. Conversely, two or more of devices 110, 120, and 130 may be located in close proximity to provide a cluster of devices for customer use. For example, the devices may be located within or near a branch office of the financial institution. The devices may be located in other locations such as retailers or merchants. Network 135 may be a computer based network, with one or more servers and/or computer processors. For example, network 135 may be the Internet or a network connected to the Internet. The network 135 may be a satellite or cellular based network. Information and data may be exchanged through the network 135 between the various components of the system 100. In alternative embodiments, the network 135 may be a local area network within the financial institution that may be connected to or interface with the Internet. It should be appreciated that the network 135 may be a combination of local area networks, wide area networks, and external networks, which may be connected to the Internet.

The processing module 140 may be communicatively coupled to the network 135. The processing module 140 may perform operations associated with the establishment, configuration, and application of the programs accordingly to exemplary embodiments. The processing module 140 may consist of one or more servers and/or general purpose computers, each having one or more computer processors associated therewith.

The processing module 140 may have a database 150 communicatively coupled thereto. The database 150 may contain data and information used by the system 100. For example, the database 150 may store account data for financial institution account holders. Additional information maybe contained therein related to the operation and administration of the system 100. The database 150 may include any suitable data structure to maintain the information and allow access and retrieval of the information. For example, the database may keep the data in an organized fashion. The database 150 may be a database, such as an Oracle database, a Microsoft SQL Server database, a DB2 database, a MySQL database, a Sybase database, an object oriented database, a hierarchical database, a flat database, and/or another type of database as may be known in the art that may be used to store and organize rule data as described herein.

The database 150 may be stored in any suitable storage device. The storage device may include multiple data storage devices. The multiple data storage devices may be operatively associated with the database 150. The storage may be local, remote, or a combination thereof with respect to the database. The database 150 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). The database may have back-up capability built-in. Communications with the database 150 may be over a network, such as the network 135, or communications may be over a direct connection between the database 150 and the processing module 140, as depicted in FIG. 1. Data may be transmitted and/or received from the database 150. Data transmission and receipt may utilize cabled network or telecom connections such as an Ethernet RJ15/Category 5 Ethernet connection, a fiber connection, a traditional phone wireline connection, a cable connection or other wired network connection. A wireless network may be used for the transmission and receipt of data.

The system 100 may have other systems 160 associated therewith. These other systems 160 may include various data collection and support systems used by the financial institution to carry out a variety of functions.

The system 100 may include a portable electronic device or mobile device 170. The portable electronic device 170 may be more than one portable electronic device. The portable electronic device 170 may be associated with a customer. The customer may interact with the portable electronic device through various input means (not shown). For example, the portable electronic device 170 may have a display screen to convey information to the customer. The display may be a color display. For example, the display may be a Liquid Crystal Display (“LCD”). The portable electronic device 170 may have one or more input devices associated with it. For example, the portable electronic device 170 may have an alpha-numeric keyboard, either physical or virtual, for receiving input. The portable electronic device 170 may have a QWERTY style keyboard, either physical or virtual. The portable electronic device 170 may have a pointing device associated therewith, such as, for example, a trackball or track wheel. As described above, the portable electronic device 170 may have communication capabilities over both cellular and wireless type networks to transmit/receive data and/or voice communications.

The portable electronic device 170, by way of non-limiting examples, may include such portable computing and communications devices as mobile phones (e.g., cell or cellular phones), smart phones (e.g., iPhones, Android based phones, or Blackberry devices), personal digital assistants (PDAs) (e.g., Palm devices), laptops, netbooks, tablets, or other portable computing devices. These portable electronic devices may communicate and/or transmit/receive data over a wireless signal. The wireless signal may consist of Bluetooth, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and/or systems suitable for transmitting and receiving data from the portable electronic device. The portable electronic device may use standard wireless protocols which may include IEEE 802.11a, 802.11b, 802.11g, and 802.11n. Such portable electronic devices may be Global Positioning System (GPS) capable. GPS is a satellite based system which sends a signal allowing a device to define its approximate position in a coordinate system on the earth. That is, the portable electronic device may receive satellite positioning data and display the location on the earth of the portable electronic device using GPS. Other location systems may be used. The portable electronic device 170 may include one or more computer processors and be capable of being programmed to execute certain tasks.

The portable electronic device 170 may establish communications with a server 180. Communications may be established over the network 135. Upon successful initiation of communications between the portable electronic device 170 and the server 180, data may be exchanged between the device 170 and the server 180. Data may be transmitted from the portable electronic device 170 to the server 180. Data may be transmitted from the server 180 to the portable electronic device 170.

According to some embodiments, the portable electronic device 170 may interact with the devices 110, 120, or 130. Through the device 110, 120, or 130, the portable electronic device 170 may interact with the server 180 or other parts of the system 100. That is, the device 110, 120, or 130 may serve as an access point to the system 100 for the portable electronic device 170. For example, a user may conduct one or more transactions with the device 110, 120, or 130 using the portable electronic device 170.

It should be appreciated that the server may interact with other parts of the system 100, such as the devices 110, 120, and 130, as well as the processing module 140 and the other systems 160. The server 180 may be a single server or it may be multiple servers. The server 180 may server a variety of roles in the system 100.

The server 180 may have one or more storage devices associated therewith. The storage may be local, remote, or a combination thereof with respect to the server 180. The storage may utilize a redundant array of disks (RAID), striped disks, hot spare disks, tape, disk, or other computer accessible storage. In one or more embodiments, the storage may be a storage area network (SAN), an Internet small computer systems interface (iSCSI) SAN, a Fiber Channel SAN, a common Internet File System (CIFS), network attached storage (NAS), or a network file system (NFS). The storage may have back-up capability built-in. The back-up capability of the storage may be used to archive image data for later use. The back-up capability may be used for recovery of data in the event of a failure of the storage.

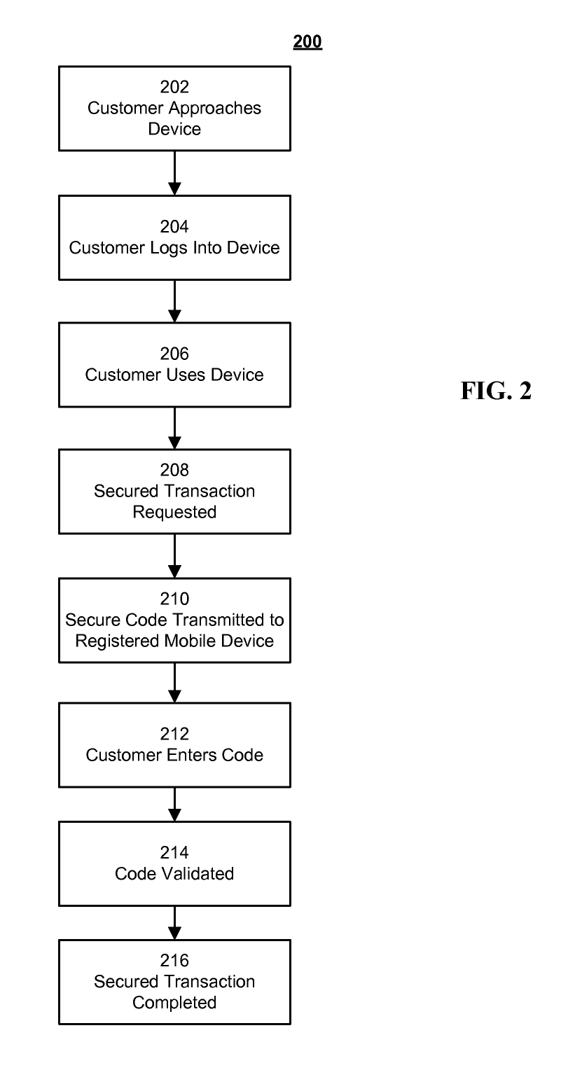

FIG. 2 depicts a flow chart of a method of interfacing with a financial services device according to exemplary embodiments of the invention. Exemplary method 200 is provided by way of example, as there are a variety of ways to carry out the methods disclosed herein. The method 200 as shown in FIG. 2 may be executed or otherwise performed by one or a combination of various systems, such as a computer implemented system. Each block shown in FIG. 2 represents one or more processes, methods, and/or subroutines carried out in the exemplary method 200. Each block may have an associated processing machine or the blocks depicted may be carried out through one processor machine.

Referring to FIG. 2, at block 202, a customer approaches a device. The device may be a financial services device, a financial services kiosk, or an ATM for example. The device, according to exemplary embodiments, may have a display area located in the front portion of the device. The display area may be used to display information for the customer. The device may have more than one display and the more than one displays may have different sizes. The display may be a touch screen type display such that the customer may interact with the display through the use of their fingers. It should be appreciated that the device may be any type of computer device or terminal with which the customer may interact. For example, the device may be a large touch screen display or a tablet computing device.

The device may be located in or near a branch office of a financial institution which may include banks, credit unions, etc. The device may be located at a retailer or merchant. For example, a financial institution may have an agreement with a merchant to allow a financial services kiosk according to exemplary embodiments to be located near or within a merchant's location. The customer may have one or more accounts with the financial institution. It should be appreciated that the customer may be associated with a different financial institution but may still be able to use the device.

At block 204, the customer logs onto/into the device. The log in may be performed using a designated log-on method for the device. The device may offer more than one log on method. This process may serve to authenticate the customer's identity. Various methods may be used to authenticate the customer and allow them to access the device. For example, the customer may swipe or otherwise present a card or similar designated device, or enter a password or PIN into an alphanumeric entry device. The customer may use a portable electronic device to log-on to the device using a wireless communication path. Other log-in methods are possible, such as biometrics. For example, a fingerprint scan or retinal scan may be used to log into the device. A combination of log-on methods may be employed. For example, the customer may provide a retinal scan and then enter a code into a keypad.

At block 206, the customer uses the device. The device may be used through a set of menu options for performing various actions. For example, the customer may use the device to conduct one or more financial transactions, such as, but not limited to, a deposit or cash withdrawal. A variety of other transactions may be performed as appreciated by one of ordinary skill in the art.

At block 208, a secured transaction is requested. At least a portion of the transactions available to the customer may be designated as a secured transaction(s). These transactions may be those that require additional verification or authentication of the customer's identity. These transactions may be identified or otherwise noted on the device interface such that the customer may be made aware of their request being for a designated secured transaction.

For example, the device may have a daily limit on cash withdrawals. In order to exceed that limit, additional verification is required. Another example may be making a deposit and then requesting an action with the deposited funds sooner than the typical funds availability window. The request may be for immediate access to the funds to either transfer and withdraw. In order to access those funds, additional verification is required.

Upon request for the secured transaction, the customer may be prompted to ensure they desired to request such a transaction.

It should be appreciated that not all customers may be presented with the same listing of secured transactions or even have such transactions available. The financial institution may prescreen or otherwise evaluate the customer and assign a risk level thereto. The risk level may determine which, if any, secured transactions the customer may conduct. Furthermore, the ability to conduct secured transactions may be limited or not available in certain geographic areas. Such measures may be used to prevent or minimize fraud possibilities associated with the verification methods described herein.

At block 210, a secured code is transmitted to the registered mobile device to the customer. The secure code is transmitted to a portable electronic device associated with the customer that has been previously registered with the financial institution. The portable electronic device is required to have an application thereon that is associated with the financial institution. The portable electronic device with the application is pre-registered by the customer with the financial institution and associated with the customer and the customer's account. In this manner, the financial institution has verified the customer's identity.

The secure code may be transmitted from the device or the financial institution. The device may send a request through its network to the financial institution requesting a transmission of the code to the customer. The financial institution may generate the code. The financial institution may transmit the code to the device so that the device has the code stored therein for comparison of the entered code in the next step.

The secure code may be of a variable length and may have alpha numeric characters. The secure code may be randomly generated. The secure may be of a different form for each transaction. The secure code may be configured to minimize fraud possibilities.

In some embodiments, a QR code or other optical code may be used. A QR code is provided as a non-limiting example. The QR code may be transmitted to the customer's device.

In some embodiments, a two-way QR code may be used. For example, the device may have the QR code displayed on its screen. The customer may image the QR code. This QR code may be processed by the customer's device, such as by an application associated with or registered with the financial institution, and a second QR code may be displayed on the customer's device for use with the device as described below. The second QR code may be generated in response to the image of the first QR code as a validation of that code. The second QR code by be generated remotely and transmitted to the customer's device. In this embodiment, the customer's device may be required to be connected to a network. Alternatively, the second QR code may be locally generated by the customer's device through the application. The application may contain coding to allow it to process the first QR code and generate the second QR code. In other embodiments, the process could be reversed such that the first QR code originates with the customer's device and then is used with the device as described below. The device may provide a second QR code for the customer's device to image. The first QR code may be generated by an application on the customer's device such as an application associated with the financial institution. The generation may occur locally at the customer's device or it may originate externally and be transmitted to the customer's device. The use of this type of QR code between the two device's (i.e., the device and the customer's device) provides security to ensure that the interaction is occurring at the location of the devices to prevent fraud.

At block 212, the customer enters the received secure code. The entry may consist of entering the code into the device. In the embodiment of a QR code or other optical code, the customer may cause the code to be displayed upon their portable electronic device and then hold this code up to an imaging device associated with the device. The device may then image the code.

At block 214, the code is validated. The device validates the code entered against the transmitted code. In the event, that the customer's identity is not successfully validated, the customer may be provided with a second opportunity to have their identity validated. In some embodiments, the method 200 may terminate upon an unsuccessful validation of the customer's identity. The customer may be able to continue with another transaction at the device but may be unable to conduct any further secured transactions during the instant session.

Following a failure to validate the customer's identity, an alert may be sent to the customer regarding the failure. This alert may serve as a method to prevent fraud by notifying the customer of the failure. The customer would then know if a third party was attempting to access their account through the device or using a stolen portable electronic device. The alert may be sent electronically to the customer via a preselected communications path configured by the customer or the financial institution. For example, the alert may be sent via a text message or email. The alert may be sent via multiple paths.

In some embodiments, the customer may be sent an alert regarding each use of the methods described herein, whether successful or unsuccessful. These alerts may serve to help prevent fraud by providing the customer notification of usage of the device with the customer's account. The alert may include postings, records, or other notifications on the financial institution's secure website to which the customer may have access with a username and password.

At block 216, the secured transaction is completed. The secured transaction is conducted.

The customer may continue to conduct one or more further transactions or log out of the device. In the event of further transactions, the method 200 may be repeated from block 206 above. For example, if the customer requests a second secured transaction, the customer may have to repeat the verification process. To this end, in some embodiments, a new secure code may be transmitted for entry by the customer. In some embodiments, the same secure code may be reentered.

In some embodiments, the order to the method 200 may be altered. For example, following log in to the device, the secure code may be transmitted to the customer and then entered into the device prior to a transaction being requested. In this manner the customer's identity may be validated at the start of the transaction session. The customer may then be able to conduct any transactions desired without additional steps.

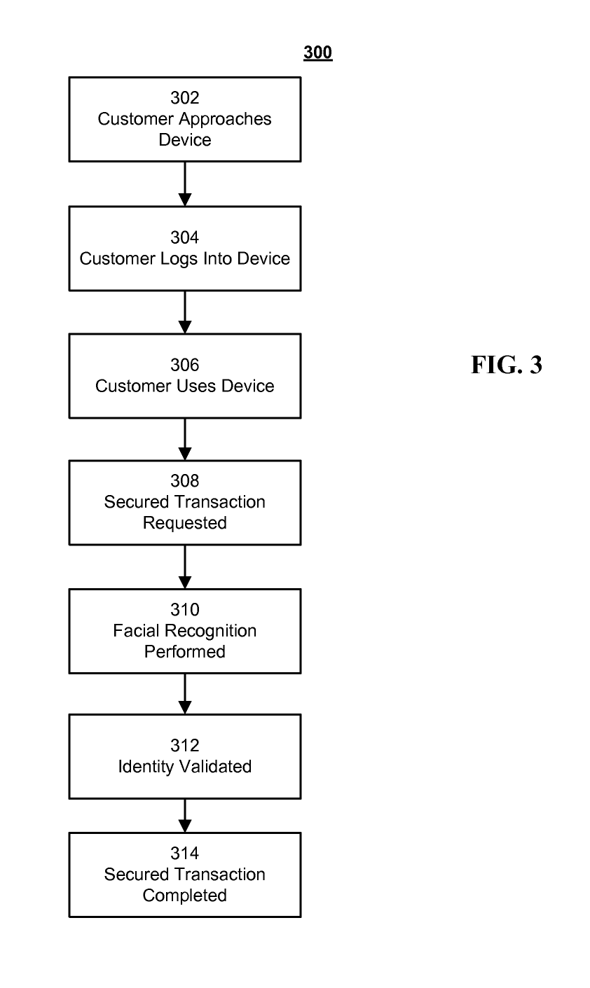

FIG. 3 depicts a flow chart of a method of interfacing with a financial services device according to exemplary embodiments of the invention. Exemplary method 300 is provided by way of example, as there are a variety of ways to carry out the methods disclosed herein. The method 300 as shown in FIG. 3 may be executed or otherwise performed by one or a combination of various systems, such as a computer implemented system. Each block shown in FIG. 3 represents one or more processes, methods, and/or subroutines carried out in the exemplary method 300. Each block may have an associated processing machine or the blocks depicted may be carried out through one processor machine.

Referring to FIG. 3, at block 302, a customer approaches a device. The device may be a financial services device, a financial services kiosk, or an ATM for example. The device, according to exemplary embodiments, may have a display area located in the front portion of the device. The display area may be used to display information for the customer. The device may have more than one display and the more than one displays may have different sizes. The display may be a touch screen type display such that the customer may interact with the display through the use of their fingers. It should be appreciated that the device may be any type of computer device or terminal with which the customer may interact. For example, the device may be a large touch screen display or a tablet computing device.

The device may be located in or near a branch office of a financial institution which may include banks, credit unions, etc. The device may be located at a retailer or merchant. For example, a financial institution may have an agreement with a merchant to allow a financial services kiosk according to exemplary embodiments to be located near or within a merchant's location. The customer may have one or more accounts with the financial institution. It should be appreciated that the customer may be associated with a different financial institution but may still be able to use the device.

At block 304, the customer logs onto/into device. The log in may be performed using a designated log-on method for the device. The device may offer more than one log on method. This process may serve to authenticate the customer's identity. Various methods may be used to authenticate the customer and allow them to access the device. For example, the customer may swipe or otherwise present a card or similar designated device, or enter a password or PIN into an alphanumeric entry device. The customer may use a portable electronic device to log-on to the device using a wireless communication path. Other log-in methods are possible, such as biometrics. For example, a fingerprint scan or retinal scan may be used to log into the device. A combination of log-on methods may be employed. For example, the customer may provide a retinal scan and then enter a code into a keypad.

At block 306, the customer uses the device. The device may be used through a set of menu options for performing various actions. For example, the customer may use the device to conduct one or more financial transactions, such as, but not limited to, a deposit or cash withdrawal. A variety of other transactions may be performed as appreciated by one of ordinary skill in the art.

At block 308, a secured transaction is requested. At least a portion of the transactions available to the customer may be designated as a secured transaction. These transactions may be those that require additional verification or authentication of the customer's identity. These transactions may be identified or otherwise noted on the device interface such that the customer may be made aware of their request being for a designated secured transaction.

For example, the device may have a daily limit on cash withdrawals. In order to exceed that limit, additional verification is required. Another example may be making a deposit and then requesting an action with the deposited funds sooner than the typical funds availability window. The request may be for immediate access to the funds to either transfer and withdraw. In order to access those funds, additional verification is required.

Upon request for the secured transaction, the customer may be prompted to ensure they desired to request such a transaction.

As described above with respect to FIG. 2, it should be appreciated that not all customers may be presented with the same listing of secured transactions or even have such transactions available. The financial institution may prescreen or otherwise evaluate the customer and assign a risk level thereto. The risk level may determine which, if any, secured transactions the customer may conduct. Furthermore, the ability to conduct secured transactions may be limited or not available in certain geographic areas. Such measures may be used to prevent or minimize fraud possibilities associated with the verification methods described herein.

At block 310, facial recognition is performed on the customer. This facial recognition may serve as the additional verification of the customer. The device may employ facial recognition software and/or hardware to image the customer's face and perform a matching of such image to an image of the customer. The customer may have provided the financial institution an image which is then archived and stored by the financial institution as well as being associated with the customer's account. The device may have a digital imaging device communicatively coupled thereto to perform the imaging. To facilitate the process, the customer may be provided with instructions to position themselves in a particular way at the device and/or to look at a particular point where the digital imaging device is located. While exemplary embodiments use facial recognition, other forms of biological and/or biometric identity validation may be used such as, for example, a retinal scan, a palm print, or a finger print. These are meant to be non-limiting examples.

At block 312, the customer's identity is validated. In the event, that the customer's identity is not successfully validated, the customer may be provided with a second opportunity to have their identity validated. In some embodiments, the method 300 may terminate upon an unsuccessful validation of the customer's identity. The customer may be able to continue with another transaction at the device but may be unable to conduct any further secured transactions during the instant session.

Following a failure to validate the customer's identity, an alert may be sent to the customer regarding the failure. This alert may serve as a method to prevent fraud by notifying the customer of the failure. The customer would then know if a third party was attempting to access their account through the device or using a stolen portable electronic device. The alert may be sent electronically to the customer via a preselected communications path configured by the customer or the financial institution. For example, the alert may be sent via a text message or email. The alert may be sent via multiple paths.

In some embodiments, the customer may be sent an alert regarding each use of the methods described herein, whether successful or unsuccessful. These alerts may serve to help prevent fraud by providing the customer notification of usage of the device with the customer's account. The alert may include postings, records, or other notifications on the financial institution's secure website to which the customer may have access with a username and password.

At block 314, the secured transaction is completed. The secured transaction is conducted.

The customer may continue to conduct one or more further transactions or log out of the device. In the event of further transactions, the method 300 may be repeated from block 306 above. For example, if the customer requests a second secured transaction, the customer may have to repeat the verification process. To this end, in some embodiments, a new secure code may be transmitted for entry by the customer. In some embodiments, the same secure code may be reentered.

In some embodiments, the method 300 may be combined with the method 200 to provide an additional layer of authentication. For example, the customer may have facial recognition performed and then may enter a secure code that they received. These steps may be performed in any order and at various points in the transaction session. For example, the facial recognition may be performed following log in to the device. In some embodiments, the facial recognition may be the log in step. The secure code may be used upon a secure transaction being requested. In other embodiments, both verification steps may be performed following the transaction request.

According to some embodiments, the device may be a portable electronic device. For example, the device may be a tablet or a tablet PC. The device may also be a computer, such as a laptop or netbook. The device may be configured to serve as a portable financial services device for conducting transactions with the financial institution. The device may have functions and features to facilitate the conduct of transactions with the financial institution. According to some embodiments, the portable electronic device may belong to the customer. For example, the device may be a cell phone, PDA, smart phone, tablet, netbook, laptop, or other portable computing device that is associated with the customer. That is, the device may not be the property of or associated with the financial institution.

In the embodiment of the portable electronic device being associated with the financial institution, the methods 200 and/or 300 may be used as above. In the embodiment of the portable electronic device being associated with the customer and being the primary transaction device, in the method 200, the secure code may still be transmitted to the device. The device being registered with the customer will ensure that the code is received by the application on the device. The customer may then enter the code as described in the method. The method 300 may be performed also on this portable electronic device using a digital imaging device associated with the portable electronic device. The facial recognition may be performed either on the portable electronic device itself or remotely by the financial institution.

According to some embodiments, as described above, the financial services device may be interacted with using a portable electronic device associated with the customer. The device may support a wireless interface for communicative coupling with the portable electronic device. The wireless interface may be a wireless signal as part of a wireless network (“wi-fi”), infrared, radio frequency identification interface (“RFID”), near field communications (“NFC”), or an optical interface. A combination of wireless interfaces may be used. The type of wireless interface impacts the degree of communicative coupling and the information exchange that can occur between the kiosk and the portable electronic device. Using a wireless signal or wireless network interface may enable two way communications and exchange of data between the kiosk and the portable electronic device. This may enable the customer to conduct a full range of transactions. Other interfaces may be limited in communication capability.

It should be appreciated that the verification methods described herein have other applications and may be used in other transactions and contexts in conjunction with conducting business at a financial institution. The verification of a customer's identity may be used to provide additional services to the customer, particularly at branches of the financial institution.

For example, while withdrawals have been used as examples above, the validation methods may be used for transactions involving funds transfers to other customers. The validation may be used on the receiving end of a funds transfer also to validate the receiver's identity.

The validation of the customer's identity may be used to allow for emergency access to a financial services device in the event the customer has lost their card or other login. The secure code may be requested by the customer using their portable electronic device and then entered directly into the financial services device. In the same manner, if facial recognition is used, it may be used for direct access to the financial services device without a separate, prior login. In such situations, however, the secured transactions may not be available.

For example, the customer's identity may be obtained and used to prepare for the customer's visit to a branch office. The customer may login at a terminal in the branch upon entering the branch and select transaction(s) they desire to perform. Some of the transactions may be secured transactions. The customer may then be asked to conduct the method as described above and enter a secure code or have facial recognition performed. When the customer reaches a customer service representative, the transaction is ready to be conducted since the customer's identity has been validated while they are waiting. In such a manner, transactions may be pre-staged based on the customer's identity. The customer service representative may ask the customer a security question to perform a final validation. Such a validation as described may be performed upon entering a parking area at the branch to further expedite service.

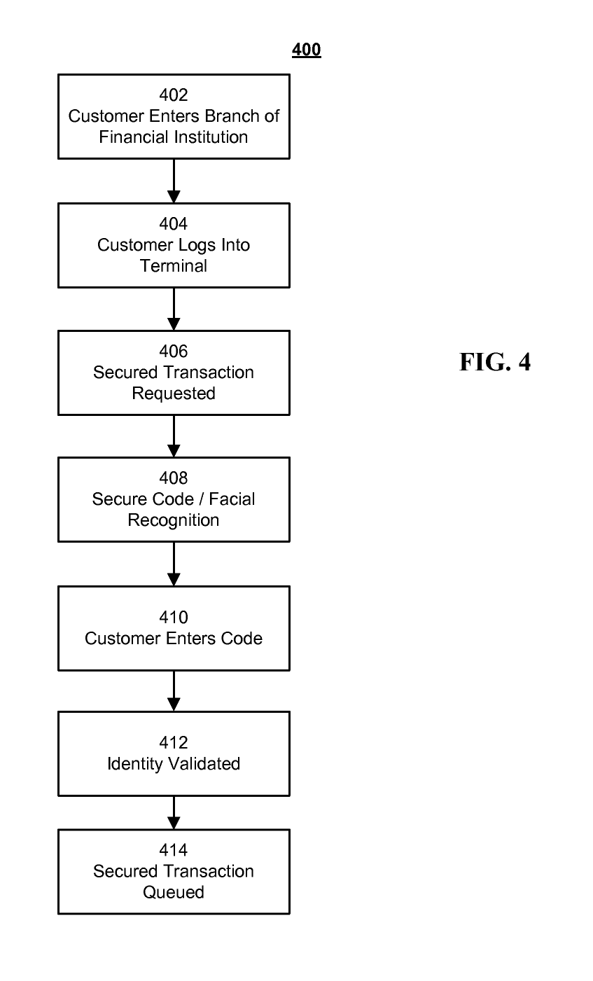

FIG. 4 depicts a flow chart of a method of interfacing with a financial services institution according to exemplary embodiments of the invention. Exemplary method 400 is provided by way of example, as there are a variety of ways to carry out the methods disclosed herein. The method 400 as shown in FIG. 4 may be executed or otherwise performed by one or a combination of various systems, such as a computer implemented system. Each block shown in FIG. 4 represents one or more processes, methods, and/or subroutines carried out in the exemplary method 400. Each block may have an associated processing machine or the blocks depicted may be carried out through one processor machine.

At block 402, a customer enters a branch of a financial institution. The branch may be a brick and mortar type building. The entry may be to the actual building or to a parking lot associated with the branch.

At block 404, the customer logs into a terminal. The terminal may be a computer terminal or computing device. For example, the terminal may be a tablet computing device or other portable electronic device. The computer may be another type of computing device. For example, the computer may be a large screen touch display.

At block 406, the customer requests a secured transaction. The secured transaction may be such as described above. The secured transaction may be another type of transaction. Also, as described above, the ability to conduct certain secured transactions may differ from customer to customer. It should be appreciated that not all transactions may require validation of the customer's identity as described. However, in some embodiments, the validation may be used for all transactions requested. In some embodiments, by completing the validation, the customer may be given priority service at the financial institution. The financial institution may have a specific line or queue for customers who desire to conduct the validation described herein.

At block 408, a secure code is transmitted to the customer or facial recognition is performed as described above. In some embodiments, both methods may be used to validate the customer's identity.

At block 410, the customer enters the code. It should be appreciated that the this block may be omitted if facial recognition is performed.

At block 412, the customer's identity is validated.

Following a failure to validate the customer's identity, an alert may be sent to the customer regarding the failure. This alert may serve as a method to prevent fraud by notifying the customer of the failure. The customer would then know if a third party was attempting to access their account through the device or using a stolen portable electronic device. The alert may be sent electronically to the customer via a preselected communications path configured by the customer or the financial institution. For example, the alert may be sent via a text message or email. The alert may be sent via multiple paths.

In some embodiments, the customer may be sent an alert regarding each use of the methods described herein, whether successful or unsuccessful. These alerts may serve to help prevent fraud by providing the customer notification of usage of the device with the customer's account. The alert may include postings, records, or other notifications on the financial institution's secure website to which the customer may have access with a username and password.

At block 414, the secured transaction is queued. The queuing is done such that when the customer's turn with a customer service representative arrives, the customer's identity may have already been validated and the transaction is queued. The customer service representative may then access the customer's record, confirm the identity validation, and complete the requested transaction. The customer service representative may be provided with an image of the customer as an added validation step to minimize or prevent fraud. In some embodiments, the customer service representative may ask the customer a security question as a final validation. The customer may therefore be provided faster service since they have identified themselves and requested the transaction while they were waiting for the next customer service representative.

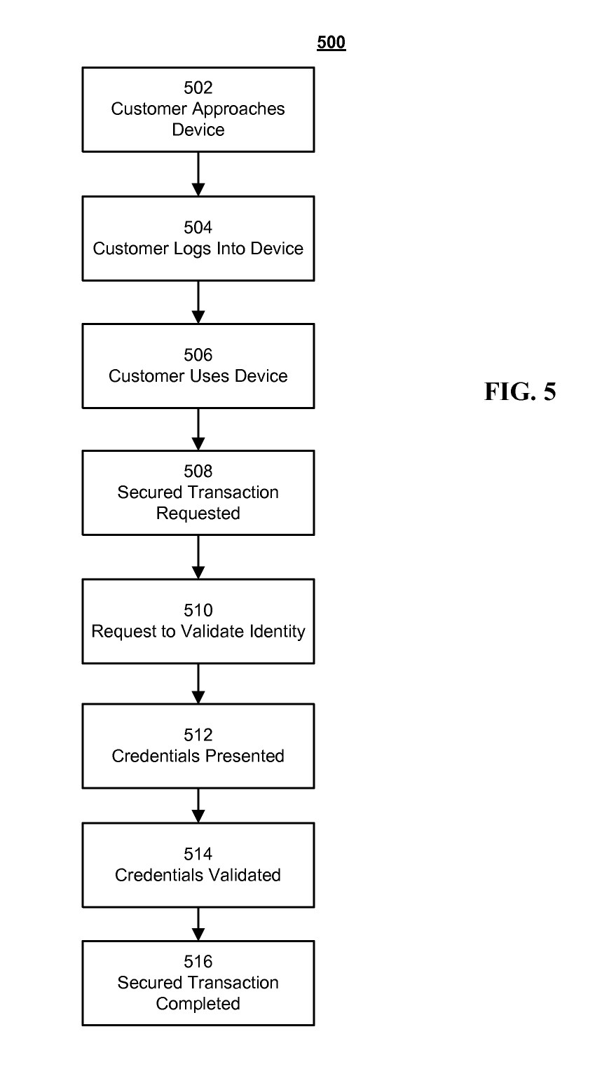

FIG. 5 depicts a flow chart of a method of interfacing with a financial services device according to exemplary embodiments of the invention. Exemplary method 500 is provided by way of example, as there are a variety of ways to carry out the methods disclosed herein. The method 500 as shown in FIG. 5 may be executed or otherwise performed by one or a combination of various systems, such as a computer implemented system. Each block shown in FIG. 5 represents one or more processes, methods, and/or subroutines carried out in the exemplary method 500. Each block may have an associated processing machine or the blocks depicted may be carried out through one processor machine.

Referring to FIG. 5, at block 502, a customer approaches a device. The device may be a financial services device, a financial services kiosk, or an ATM for example. The device, according to exemplary embodiments, may have a display area located in the front portion of the device. The display area may be used to display information for the customer. The device may have more than one display and the more than one displays may have different sizes. The display may be a touch screen type display such that the customer may interact with the display through the use of their fingers. It should be appreciated that the device may be any type of computer device or terminal with which the customer may interact. For example, the device may be a large touch screen display or a tablet computing device.

The device may be located in or near a branch office of a financial institution which may include banks, credit unions, etc. The device may be located at a retailer or merchant. For example, a financial institution may have an agreement with a merchant to allow a financial services kiosk according to exemplary embodiments to be located near or within a merchant's location. The customer may have one or more accounts with the financial institution. It should be appreciated that the customer may be associated with a different financial institution but may still be able to use the device.

At block 504, the customer logs onto/into the device. The log in may be performed using a designated log-on method for the device. The device may offer more than one log on method. This process may serve to authenticate the customer's identity. Various methods may be used to authenticate the customer and allow them to access the device. For example, the customer may swipe or otherwise present a card or similar designated device, or enter a password or PIN into an alphanumeric entry device. The customer may use a portable electronic device to log-on to the device using a wireless communication path. Other log-in methods are possible, such as biometrics. For example, a fingerprint scan or retinal scan may be used to log into the device. A combination of log-on methods may be employed. For example, the customer may provide a retinal scan and then enter a code into a keypad.

At block 506, the customer uses the device. The device may be used through a set of menu options for performing various actions. For example, the customer may use the device to conduct one or more financial transactions, such as, but not limited to, a deposit or cash withdrawal. A variety of other transactions may be performed as appreciated by one of ordinary skill in the art.

At block 508, a secured transaction is requested. At least a portion of the transactions available to the customer may be designated as a secured transaction(s). These transactions may be those that require additional verification or authentication of the customer's identity. These transactions may be identified or otherwise noted on the device interface such that the customer may be made aware of their request being for a designated secured transaction.

For example, the device may have a daily limit on cash withdrawals. In order to exceed that limit, additional verification is required. Another example may be making a deposit and then requesting an action with the deposited funds sooner than the typical funds availability window. The request may be for immediate access to the funds to either transfer and withdraw. In order to access those funds, additional verification is required.

Upon request for the secured transaction, the customer may be prompted to ensure they desired to request such a transaction.

It should be appreciated that not all customers may be presented with the same listing of secured transactions or even have such transactions available. The financial institution may prescreen or otherwise evaluate the customer and assign a risk level thereto. The risk level may determine which, if any, secured transactions the customer may conduct. Furthermore, the ability to conduct secured transactions may be limited or not available in certain geographic areas. Such measures may be used to prevent or minimize fraud possibilities associated with the verification methods described herein.

At block 510, validation is requested. The customer is asked to present validation of their identity to the device. According to exemplary embodiments, the customer may be prescreened such that they have been precredentialed with credentials on their mobile device. These credentials may be loaded on the customer's mobile device, which, as described above, may be preregistered with the financial institution. The credentials may be loaded into or be a part of an application associated with the financial institution. The credentials may be secure, such as, for example, being encrypted. By being secure, the credentials may not be modified or altered by the customer.

The credentials may be in a variety of different forms. For example, the credentials may be a secure code of a variable length and may have alpha numeric characters. In some embodiments, a QR code or other optical code may be used as the credentials. A QR code is provided as a non-limiting example. In other embodiments, the credentials may be electronic such that they are transmitted or used through radio frequency identification (RFID) or near field communications (NFC).

At block 512, the credentials are entered into the device. The customer enters or transmits the credentials to the device. For example, the entry may consist of entering the code into the device. In the embodiment of a QR code or other optical code, the customer may cause the code to be displayed upon their portable electronic device (such as by accessing the application) and then hold this code up to an imaging device associated with the device. The device may then image the code. In the embodiment of RFID or NFC, the customer may wave or pass their device over a particular location on the device containing a RFID or NFC sensor or receiver. The device may provide appropriate instructions to the customer to complete this step.

At block 514, the credentials are validated. The device validates the credentials entered or received. In the event, that the customer's identity is not successfully validated, the customer may be provided with a second opportunity to have their identity validated. In some embodiments, the method 500 may terminate upon an unsuccessful validation of the customer's identity. The customer may be able to continue with another transaction at the device but may be unable to conduct any further secured transactions during the instant session. The validation ensures the customer's identity is validated and that the device is the pre-registered device that was credentialed.

Following a failure to validate the customer's identity, an alert may be sent to the customer regarding the failure. This alert may serve as a method to prevent fraud by notifying the customer of the failure. The customer would then know if a third party was attempting to access their account through the device or using a stolen portable electronic device. The alert may be sent electronically to the customer via a preselected communications path configured by the customer or the financial institution. For example, the alert may be sent via a text message or email. The alert may be sent via multiple paths.

In some embodiments, the customer may be sent an alert regarding each use of the methods described herein, whether successful or unsuccessful. These alerts may serve to help prevent fraud by providing the customer notification of usage of the device with the customer's account. The alert may include postings, records, or other notifications on the financial institution's secure website to which the customer may have access with a username and password.

At block 516, the secured transaction is completed. The secured transaction is conducted.

The customer may continue to conduct one or more further transactions or log out of the device. In the event of further transactions, the method 500 may be repeated from block 506 above. For example, if the customer requests a second secured transaction, the customer may have to repeat the verification process.

The method 500 may be modified according to exemplary embodiments. The customer may be able to predetermine a particular transaction they wish to conduct at the device. For example, the customer may know they wish to withdraw $250 from the device. Using their preregistered mobile device and the installed application, the customer may select this transaction and designate the particular device they wish to conduct this transaction at. The customer may approach and log into the device as described above in the method 500, however the customer, instead of selecting a transaction from the device, is prompted to validate their identity as described above starting at block 510 by presenting their credentials. Once their identity is validated, then the transaction is automatically conducted. This embodiment may be used for any transaction, not just secured transactions.

In other embodiments, the customer, after designating their desired transaction and location, may approach the device and present their mobile device to the device. The device may read the code from the screen as described above or receive a transmission of the code from the mobile device and complete the transaction upon successful validation of the customer's identity.

Accordingly, the method 500 and its various embodiments, provides a method of allowing a customer to be prevalidated or prescreened and be provided with appropriate credentials to validate their identity. These credentials may be loaded onto the customer's mobile device to allow portability of these credentials and flexibility in their usage. For example, the method 500 and this concept may be extend to the various embodiments of validation of a customer's identity during service at a branch of the financial institution as described above with respect to the method 400.

Hereinafter, aspects of implementation of the inventions will be described. As described above, the method of the invention may be computer implemented as a system. The system of the invention or portions of the system of the invention may be in the form of a “processing machine,” for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

The description of exemplary embodiments describes servers, portable electronic devices, and other computing devices that may include one or more modules, some of which are explicitly depicted in the figures, others are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, portable electronic devices, client devices, computers, etc.) separately. The functions described as being performed at various components may be performed at other components, and the various components may be combined and/or separated. Other modifications also may be made.

According to exemplary embodiments, the systems and methods may be computer implemented using one or more computers, incorporating computer processors. The computer implementation may include a combination of software and hardware. The computers may communicate over a computer based network. The computers may have software installed thereon configured to execute the methods of the exemplary embodiments. The software may be in the form of modules designed to cause a computer processor to execute specific tasks. The computers may be configured with hardware to execute specific tasks. As should be appreciated, a variety of computer based configurations are possible.

The processing machine described above may also utilize any of a wide variety of other technologies including a special purpose computer, a computer system including a microcomputer, mini-computer or mainframe for example, a programmed microprocessor, a micro-controller, a PICE (peripheral integrated circuit element), a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices for example capable of implementing the steps of the process of the invention.

It is appreciated that in order to practice the method of the invention as described above, it is not necessary that the processors and/or the memories of the processing machine be physically located in the same geographical place. For example, each of the processors and the memories and the data stores used in the invention may be located in geographically distinct locations and connected so as to communicate in any suitable manner. Additionally, it is appreciated that each of the processor and/or the memory and/or data stores may be composed of different physical pieces of equipment. Accordingly, it is not necessary that the processor be one single piece of equipment in one location and that the memory be another single piece of equipment in another location. For example, it is contemplated that the processor may be two or more pieces of equipment in two or more different physical locations. These two or more distinct pieces of equipment may be connected in any suitable manner. Additionally, the memory may include two or more portions of memory in two or more physical locations. Additionally, the data storage may include two or more components or two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions. It is also appreciated that the data storage performed by two distinct components as described above may, in accordance with a further embodiment of the invention, be performed by a single component. Further, the data storage performed by one distinct component as described above may be performed by two distinct components.

Further, various technologies may be used to provide communication between the various processors and/or memories, as well as to allow the processors and/or the memories of the invention to communicate with any other entity; e.g., so as to obtain further instructions or to access and use remote memory stores, for example. Such technologies used to provide such communication might include a network, such as a computer network, for example, the Internet, Intranet, Extranet, LAN, or any client server system that provides communication of any capacity or bandwidth, for example. Such communications technologies may use any suitable protocol such as TCP/IP, UDP, or OSI, for example. It should be appreciated that examples of computer networks used in the preceding description of exemplary embodiments, such as the Internet, are meant to be non-limiting and exemplary in nature.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming or any other suitable programming form. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various embodiments of the invention. Illustratively, the programming language used may include assembly language, Ada, APL, Basic, C, C++, C#, COBOL, dBase, Forth, Fortran, Java, Modula-2, Pascal, Prolog, REXX, Ruby, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, e.g., the software for example, that enables the computer operating system to perform the operations described above may be contained on any of a wide variety of computer readable media, as desired. Further, the data for example processed by the set of instructions might also be contained on any of a wide variety of media or medium. For example, the particular medium, e.g., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, e.g., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

While the embodiments have been particularly shown and described within the framework of financial services devices, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, combinations of the present embodiments, and uses and advantages of the present invention will be apparent to those skilled in the art from consideration of the specification and practice of the invention disclosed herein. The specification and examples should be considered exemplary.

1. A computer implemented method, comprising:
registering a portable electronic device with a financial institution such that the portable electronic device is identified as belonging to a customer who is associated with at least one account administered by the financial institution, wherein registering comprises installing a mobile application associated with the financial institution on the portable electronic device;
receiving, electronically, a log-in request to a financial services device from the customer;
authenticating an identity of the customer based on the log-in request;
receiving, electronically, a transaction request at the financial services device from a customer following the log-in request and authentication, wherein the transaction request is received following authentication of the customer and the transaction request is not permitted to be conducted according to one or more predetermined settings;
transmitting, electronically, following the transaction request, a code to the registered portable electronic device associated with the customer, wherein the code is accessible from the installed mobile application;
receiving, electronically, an entry of the code at the financial services device;
performing, electronically, a comparison of the entered code with the transmitted code;
overriding the one or more predetermined settings to enable completion of the transaction; and
completing the transaction.

2. The method of claim 1, wherein the portable electronic device comprises one of:
a smart phone and a tablet computing device.

3. The method of claim 1, wherein the code is an optically read code.

4. The method of claim 3, wherein the entry of the code comprises optically reading the code by the financial services device from the portable electronic device.

5. (canceled)

6. The method of claim 1, wherein the code is a randomly generated alpha-numeric code.

7. The method of claim 1, wherein the transaction request is for a secured transaction.

8. The method of claim 7, wherein the secured transaction is a transaction not permitted to be conducted without an override at the financial services device according to the one or more predetermined settings established by the financial institution.

9. The method of claim 1, further comprising:
denying the transaction request upon an unsuccessful comparison.

10. A system, comprising:
a processor; and
a memory comprising computer-readable instructions which when executed by the processor cause the processor to perform the steps comprising:
registering a portable electronic device with a financial institution such that the portable electronic device is identified as belonging to a customer who is associated with at least one account administered by the financial institution, wherein registering comprises installing a mobile application associated with the financial institution on the portable electronic device;
receiving, electronically, a log-in request to a financial services device from the customer;
authenticating an identity of the customer based on the log-in request;
receiving a transaction request at the financial services device from a customer, following the log-in request and authentication, wherein the transaction request is received following authentication of the customer and the transaction request is not permitted to be conducted according to one or more predetermined settings;
transmitting, following the transaction request, a code to the registered portable electronic device associated with the customer, wherein the code is accessible from the installed mobile application;
receiving an entry of the code at the financial services device;
performing a comparison of the entered code with the transmitted code;
overriding the one or more predetermined settings to enable completion of the transaction, upon a successful comparison; and
completing the transaction.

11. The system of claim 10, wherein the portable electronic device comprises one of: a smart phone and a tablet computing device.

12. The system of claim 10, wherein the code is an optically read code.

13. The system of claim 12, wherein the entry of the code comprises optically reading the code by the financial services device from the portable electronic device.

14. (canceled)

15. The system of claim 10, wherein the code is a randomly generated alpha-numeric code.

16. The system of claim 10, wherein the transaction request is for a secured transaction.

17. The system of claim 16, wherein the secured transaction is a transaction not permitted to be conducted without an override at the financial services device according to the one or more predetermined settings established by the financial institution.

18. The system of claim 10, further comprising:
denying the transaction request upon an unsuccessful comparison.

19.-46. (canceled)
